(19) United States
(12) Patent Application Publication
(10) Pub. No.: US 2006/0015732 A1
(43) Pub. Date: Jan. 19, 2006

(54) Processing system using internal digital signatures

(75) Inventor: Zhengrong Liu, Foster City, CA (US)

Correspondence Address: CARPENTER & KULAS, LLP, 1900 EMBARCADERO ROAD, SUITE 109, PALO ALTO, CA, 94303, US

(73) Assignees: Sony Corporation; Sony Electronics, Inc.

(21) Appl. No.: 10/893,139

(22) Filed: Jul. 15, 2004

(51) Int. Cl. H04L 9/00; G06F 12/14; H04L 9/32; G06F 11/30

(52) U.S. Cl. 713/176; 713/193; 713/164

(57) ABSTRACT

A preferred embodiment of the invention uses local or internal public and private keys for signatures. The keys are obtained and managed internally by a kernel process having access to a secure key storage area. The kernel process is booted within a trusted platform and is the only process that is allowed to access the key storage area. The internal keys can be used in addition to external keys for both internal key-based and external key-based signatures on a single digital item. In a preferred embodiment, the kernel process also maintains revocation lists and is synchronized with other entities by having the same criteria (e.g., time-based) for revoking or expiring known internal keys

### CROSS REFERENCE TO RELATED APPLICATIONS

This patent application is related to the following co-pending patent applications: U.S. patent application Ser. No. ______ filed on ______ entitled SYSTEM AND METHOD FOR STORING ATTRIBUTES IN A FILE FOR PROCESSING AN OPERATING SYSTEM (attorney docket no. 020699-101200US); U.S. patent application Ser. No. ______ filed on ______ entitled ESTABLISHING A TRUSTED PLATFORM IN A DIGITAL PROCESSING SYSTEM (attorney docket no. 020699-101300US); U.S. patent application Ser. No. ______ filed on ______ entitled USE OF KERNEL AUTHORIZATION DATA TO MAINTAIN SECURITY IN A DIGITAL PROCESSING SYSTEM (attorney docket no. 020699-101400US); and U.S. patent application Ser. No. ______ filed on ______ entitled SYSTEM AND METHOD FOR AUTHORIZING THE USE OF STORED INFORMATION IN AN OPERATING SYSTEM (attorney docket no. 020699-101500US).

### BACKGROUND OF THE INVENTION

This invention is related in general to digital processing systems and more specifically to enforcing security in a processing platform by using internal signatures.

In many of today's computing or processing applications it is desirable for a manufacturer, distributor or owner of content or information to be able to protect the content from misuse. For example, a Digital Versatile Disk (DVD) player is used by consumers to show movies and video that is typically proprietary. The owner of the movie content wishes to prevent a user from unauthorized copying, distribution or other handling of the content. Similarly, a compact disc (CD) player can have the same concerns with respect to music or other audio information. Other processing systems may have proprietary content in the form of software application programs, games, etc. In each of these cases protecting the content can be difficult since the processing platform (e.g., DVD player, CD player, game console, etc.) is under the control of the end user who typically operates the processing platform in their home.

One approach to ensuring protection of content is to use a digital “signature.” The signature provides proof that a known trusted entity has generated the content of a digital item. For example, a receiving processor can check the signature to verify that a known sender was, indeed, the originator of the item. Any type of digital item or information can be signed. For example, documents, audio, images, video, program code or any other form of digital information can be signed and transferred with the knowledge that the receiver will be able to achieve an acceptable level of certainty that the signing entity has sent the digital item.

One form of a digital signature is formed by computing a “hash” over all or a portion of the contents of a digital item to be protected. A routine can combine bytes, words or other units of the item's data to achieve a hash value of a few bytes or more. The hash value is typically generated by the signing, or sending, entity but it can be generated at other locations or by other entities, as desired. The hash value is encrypted (i.e., signed) with a private key of the signing entity along with information that identifies the signing entity. Other approaches can vary in the amount and type of information that is encrypted.

When the signed item is transferred to a receiving entity the receiving entity uses a public key corresponding to the sender's private key to decrypt the signature and verify the sender's identity and recover the hash value. The hash value is again computed over the contents of the item contents and checked against the recovered hash value to make sure there is a match. If there is not a match then the receiver assumes that the item contents have been tampered and the item contents can be discarded, or flagged as “not trusted.” On the other hand, if there is a match the receiver has confidence that the item is intact and was received as intended by the sender.

Other signature variations are possible. For example, an item can be encoded with a first key, typically a “symmetrical” key, and the symmetrical key can be included as part of signed data that is encrypted with the sender's private signature key so that the symmetrical key can be recovered by the receiver and used to decrypt the item.

One additional resource typically used with signatures is a Certificate Authority (CA)—a trusted source that provides public keys to receivers so that the receiver can know that they have the correct public key associated with a sender. The CA maintains a list of key pairs (public key and corresponding private key) associated with different entities. In some cases a CA is part of a “trust hierarchy” of successively superior CAs that can authenticate the identity of each lower CA in the hierarchy.

CAs are typically secure processing systems that are remotely located and managed and that allow other processors to obtain keys over a network such as the Internet, public or private intranets, local area networks (LANs); corporate, campus or home networks, etc. One drawback of this approach is that a processor or other entity trying to obtain a key must be connected to the network and must go through request, approval, authorization and receipt steps to obtain the key. Such a process can be time-consuming. Also, in cases where a device is not always (or never) connected to the network, the use of an online central CA may be an inefficient or impossible approach. For example, in consumer electronic devices a user is usually in control of whether the device (e.g., a Digital Versatile Disk (DVD) player, set-top box, etc.) is connected to a network or not.

Typically, the key pairs expire after a predefined period of time or upon the occurrence of an event. Thus, another function performed by a CA includes notifying subscribing entities when keys have expired. Such notification is often in the form of a “revocation list.” Again, with a central CA approach each entity must perform a network transaction to obtain notice of a revoked or expired key and must then obtain the new key.

Many approaches to centralized CA management are possible. For example, one popular approach includes the Public Key Infrastructure (PKI). Often a processing entity also strives to create and maintain a “trusted platform” in which digital signature processing can occur with a minimized chance of being compromised. Such a trusted platform only allows known, or trusted, processes to execute so that undesirable functionality, such as undesirable copying of the content, is inhibited. A prior art approach to achieving a trusted platform includes standards promulgated by Trusted Computing Group (TCG, formerly Trusted Computing Platform Alliance (TCPA)) such as TCG Trusted Platform Module (TPM) v1.2 Specification Revision 62, Oct. 2, 2003. This specification design includes a hardware chip TPM and related functions that provide mechanisms to establish certain levels of trusts to local and remote platforms.

A TPM is integrated into a platform and protects a set of Platform Configuration Registers (PCRs) for storing runtime configurations of the platform. Platform configurations are measured (e.g., hashed) and extended (or accumulated) into PCRs. TCG specifies some protected functions for applications to query platform configurations. Using these functions, an application is able to acquire configurations for local or remote platforms.

A trusted chain is established by measuring platform configurations and extending the values to PCRs during a boot sequence. At platform power-on or reset, a root process of the trust module measures system hardware and firmware configurations including the Initial Program Loader (IPL or operating system (OS) loader). The measurements are extended to PCRs before passing over the platform control to the OS loader. The OS loader, in turn, measures the kernel image and related configurations before handling over the system control to the kernel image.

### BRIEF SUMMARY OF THE INVENTION

A preferred embodiment of the invention uses local or internal public and private keys for signatures. The keys are obtained and managed internally by a kernel process having access to a secure key storage area. The kernel process is booted within a trusted platform and is the only process that is allowed to access the key storage area. The internal keys can be used in addition to external keys for both internal key-based and external key-based signatures on a single digital item.

In one embodiment the invention provides a method for securing data items transferred from a sending device to a receiving device, the method comprising storing a plurality of internal keys in a secure data area of the sending device; storing a plurality of corresponding internal keys in a secure data area of the receiving device; using a first one of the internal keys in the sending device to sign a first data item at the sending device; transferring the signed first data item to the receiving device; using a first internal key at the receiving device to verify the integrity of the first data item, wherein the first internal key at the receiving device corresponds to the first one of the internal keys in the sending device; selecting a second one of the internal keys in the sending device, wherein the selecting is done without communication external to the sending device; using the selected internal key to sign a second data item; transferring the signed second data item to the receiving device; and using a second internal key at the receiving device to verify the integrity of the second data item, wherein the second internal key at the receiving device corresponds to the second one of the internal keys in the sending device, wherein the second internal key at the receiving device is selected without communication external to the receiving device.

### BRIEF DESCRIPTION OF THE DRAWINGS

FIG. 1 is a diagram of a key hierarchy;

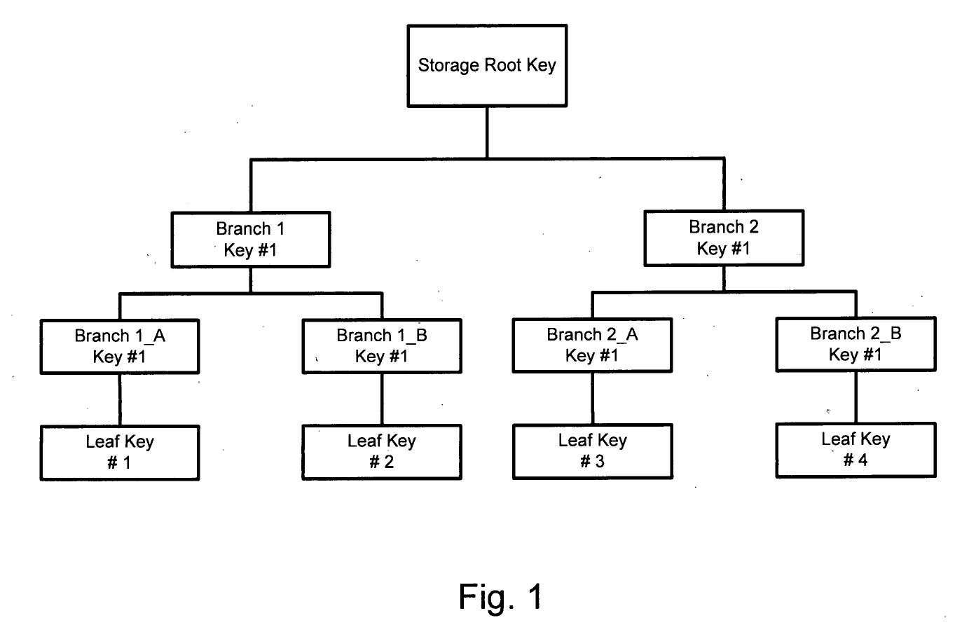

FIG. 2 shows basic hardware and software used in a startup procedure of a digital processing platform; and

FIG. 3 shows basic steps in a boot sequence according to the present invention.

### DETAILED DESCRIPTION OF THE INVENTION

A preferred embodiment of the invention uses a kernel process to manage and control internal cryptographic keys in a processing system. The kernel is provided with secure and exclusive authorization to access keys in a key hierarchy by reading Kernel Authorization Data (KAD) from a secure storage location. The KAD (e.g. a key) is used to internally sign digital items.

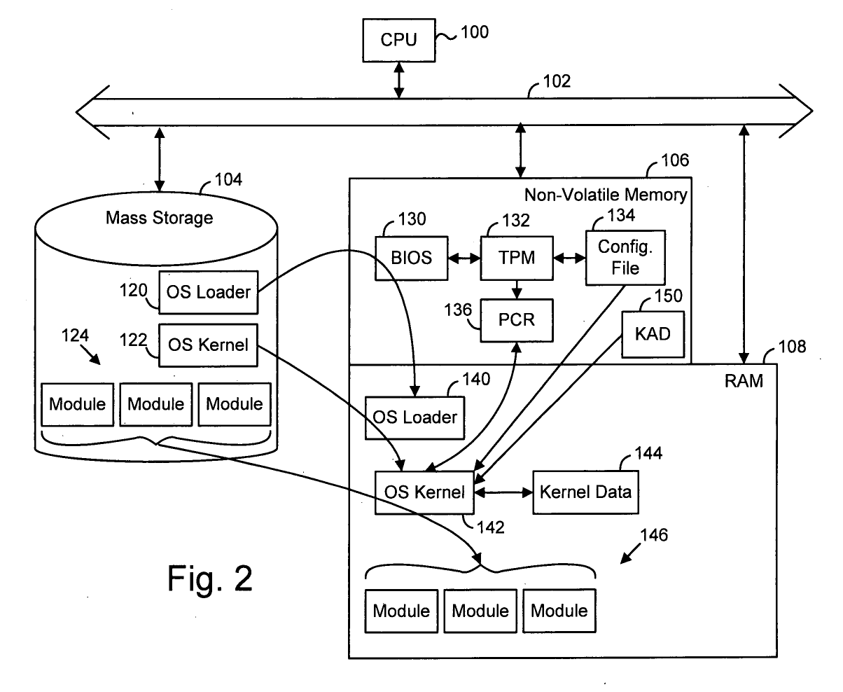

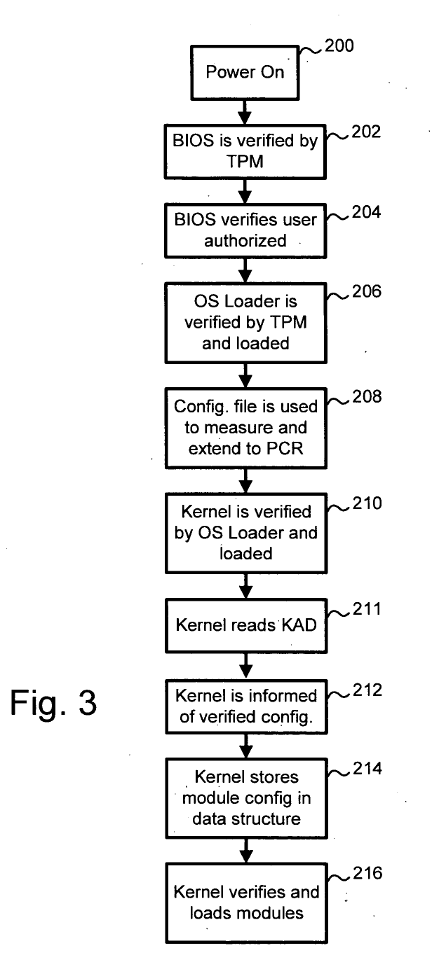

The kernel obtains the KAD as soon as possible in the boot sequence. FIGS. 2 and 3 are discussed, below, to-illustrate possible points in a boot procedure where the kernel might obtain the KAD. A persistent storage area is used to hold KAD data for the root key and/or other keys used by the kernel or other specialized processes. The authorization data, and the keys it protects, can be used to protect other portions of, or the entire, key structure. The persistent storage area is reserved in a TPM or similar security hardware and, in a preferred embodiment, is loaded by a manufacturer or other trusted entity prior to shipping a device to an end user.

FIG. 2 is a diagram showing basic hardware and software used in a startup procedure, or “boot sequence” of a digital processing platform. The platform can be any type of processing device such as a DVD player, television, personal computer, etc. In general, any suitable type of architecture and allocation of processing among hardware and software can be suitable for use with the present invention. FIG. 2 is discussed in relation to the flowchart of FIG. 3, which describes the basic steps, or functionality, of a boot sequence designed to maintain the integrity of a trusted platform.

The device of FIG. 2 includes a central processing unit (CPU) 100, bus 102, mass storage 104, non-volatile memory 106 and random access memory (RAM) 108. CPU 100 is in communication with the other device components via the bus in a manner as is known in the art. Additional components can be present in other embodiments of the invention. For example, an input/output (I/O) subsystem, wireless communications system, direct memory access (DMA) controller, display adapter, keyboard and mouse controller, etc., can be used in different devices. Some devices may not use all of the components shown in FIG. 2, or may use components (either hardware or software) in varying number, type and arrangement. In general, any type of processing architecture can be sufficient for use with the present invention. A platform can use, for example, hardware and software components by Intel™ Corp., and Microsoft™, Inc. However, any other suitable platform components can be employed.

Mass storage 104 can be, for example, a hard disk drive unit. Other types of mass storage are possible such as a memory stick, CDROM drive, DVD drive, networked source, etc. Non-volatile memory can be any type of persistent memory. For example, read-only memory (ROM), flash memory, etc., can be used. Although specific types of storage media are presented, other embodiments can use other media types. The illustration of specific functionality stored in, or accessed from, a particular media type is not limiting of the present invention as other designs may effectively use any suitable type of storage medium.

Startup of a trusted platform occurs when a user turns on power to a device. A power-on step is shown at 200 of FIG. 3. Turning on power causes the subsequent steps of the flowchart to be executed by the processor to initiate a boot sequence to achieve a trusted platform. Initiation of the boot sequence can also be triggered by, e.g., a system reset, or by an external event, such as an instruction to restart the system upon detection of loss of trust in the system, detection of tampering or other events.

At step 202 of FIG. 3 the Basic Input-Output System (BIOS) is verified by TPM. In a preferred embodiment, BIOS verification can be performed according to the TCG Trusted Platform Module (TPM) v1.2 Specification Revision 62, Oct. 2, 2003 (“TPM Specification”), which is incorporated by reference as if set forth in full in this document. However, other types of verification can be performed in place of, or in addition to, those in the TPM Specification.

As described in the TPM Specification, to ensure system integrity for the trusted platform, “integrity metrics” are used. These include measurements of key platform characteristics that can be used to establish platform identity, such as BIOS, boot-loader, hardware configuration, OS loader, OS security policy and other characteristics. Cryptographic hashing, as is known in the art, is employed to extend trust from known trusted components to additional components as the boot sequence progresses. In a preferred embodiment, the measurements are extended to kernel modules and other modules that will be executed within the trusted platform. Critical applications that will be run within the trusted platform are monitored. Other kernel enhancements are used which are described in detail in the related patent applications referenced, above.

In the TPM Specification approach to security, a Core Root of Trust for Measurement (CRTM) is established to provide secure measurement functions. The TPM provides secure storage and measurement reporting along with other cryptographic services. The measurements the CRTM makes are based on the platform's architecture, therefore the CRTM remains platform dependent. Trusted support services can be provided to support secure I/O operations, cryptographic and other functions. In order to maintain the integrity of the trusted platform, both the CRTM and TPM must be protected against hardware and software attacks. The level of protection is specified in the particular platform's protection profile and is certified at manufacture. Upgrades and modifications are allowed only according to the manufacturer's (or whoever certifies the platform) instructions and authorization.

The CRTM measures integrity metrics during system initialization and during runtime. Integrity metrics include data reflecting the integrity of the software state. In the case of a PC, metrics can include the BIOS, MBR, and any other firmware bound to the board. The measurement is a hash of the software or firmware code. These measurements reflect the current state of the software (version, patch level, etc.). If the CRTM measurement of the BIOS code does not match a known value, the system may cease booting, or may boot and simply report the state as “not trusted” after the boot sequence is finalized.

The CRTM provides security throughout the boot and run process by extending its root of trust into a chain of trust, providing evidence that the system boot was carried out by trusted firmware. The CRTM first measures and reports on itself. Then it reports on the BIOS. The BIOS measures (via CRTM/TPM services) and loads the boot loader. The boot loader, in turn, measures the OS and the OS, can use the TPM at anytime to measure other applications. As long as software is measured and the result stored before execution, any unauthorized software cannot hide itself. If unauthorized software is present, it will be reflected in a measurement that is stored in the TPM.

The mechanics of measurement and storage provide methods to ensure that the reported values are reliable. The TPM contains (in protected storage) both a measurement log and Platform Configuration Registers (PCRs). The log contains a full history of all measurements and the PCRs contain values representing a sequence of measurements (but not the actual integrity metric).

At step 202, to verify and extend trust to the BIOS from the TPM, the TPM and BIOS communicate and BIOS 130 (of FIG. 2) is measured by TPM 132. The measurement (e.g., a hash) is extended (or stored) in TPM 132 and/or Platform Configuration Registers (PCRs) 136.

At step 206 of FIG. 3 the OS Loader is verified by TPM and is loaded. Note that although specific components are said to perform certain verification steps in the preferred embodiment, other embodiments can use different components to perform the specific verifications and the performance can occur at different times. In some applications, certain verification steps can be omitted and/or verification steps can be added. For example, step 206 may be performed by the BIOS (after the BIOS has been verified) or by another component, as desired.

FIG. 2 shows OS Loader 120 being loaded from mass storage by BIOS 130 into RAM 108 to create OS Loader instance 140. OS Loader 140 is then executed from RAM 108 by CPU 100.

In FIG. 3, step 208 is executed to measure and extend trust for modules to the PCR. Trusted modules are listed in a configuration file or data structure including the hash values for the modules. Configuration files are created separately, usually on different platforms. The configuration files typically list the hash values of trusted modules. The measurement of configuration files is extended in PCRs at the boot sequence not later than the kernel image. The data for the modules is extended, at least in part, to one or more values in the PCRs before a kernel begins executing. At step 210, OS Kernel 122 is verified by OS Loader instance 140 and is loaded into RAM 108 as OS Kernel instance 142. The loaded OS Kernel instance is allowed to execute to take control of the platform and verify modules 124 to be loaded (e.g., through standard “insmod” or “modprobe” routines). The OS Kernel instance is provided with data from configuration file 134 to indicate verified (i.e., “trusted”) modules (step 212). The OS Kernel instance stores module configuration information in Kernel data structure 144 (step 214) and verifies each module against a hash in configuration file 134 before loading modules 124 and allowing the loaded modules to execute as module instances 146 (step 216). If an untrusted module is loaded the kernel changes the PCR values to indicate that the system is not trustable any more.

A boot process incorporating a kernel read of KAD 150 data can allow the kernel (or another process) to read the KAD at different times in the boot sequence. Embodiments of the invention contemplate a kernel read of KAD at a time occurring after steps 210, 212, 214 or 216 as shown in FIG. 3. In other words, the kernel can read the KAD after the kernel is verified and loaded by the OS loader (step 210); after the kernel is informed of a verified configuration (step 212); after the kernel stores module configuration information (step 214); or after the kernel has verified and loaded one or more modules (step 216). A preferred embodiment performs the KAD read at step 211 after step 210 when the kernel has been verified and loaded. In a preferred embodiment the KAD is read only once and thereafter further access to KAD data is electronically inhibited. Hardware can be provided to ensure that reading of the KAD is allowed only once upon power-on or other hard reset of the device. At each power-down, or reset, a flag that indicates that the KAD has been read is reset to allow for another single attempted read operation of the KAD at the next boot sequence.

In the preferred embodiment, platform configuration measurements are updated for use at run-time by client applications and other processes. New PCR values are available and reflect the current state of the platform (i.e., trusted or non-trusted) for processes executing after the boot sequence completes. Thus, any non-trusted extension to the kernel (e.g., as a result of intruder or hacker actions) is reflected dynamically in ongoing PCR queries. Client applications can determine if the platform is trustable based on the return of PCR values.

The preferred embodiment uses the configuration file to protect the integrities of the trusted modules. The stored hash value of the configuration file in a PCR protects the “signatures” of the configuration file and modules. Digital signatures can also be used to protect integrities of modules, thus providing flexibility for introducing new modules and upgrading existing modules. Thus, integrity of new modules can be achieved in a self-contained device.

In alternative embodiments, a system can implement both a hash table for kernel modules that are unlikely to be changed in the short term, and a digital signature mechanism for other modules, such as third party kernel modules. Any executable code, data files, program objects or other information can be included in a measurement. The security extensions afforded to modules, described above, can be applied to any type of function or information in a processing system to ensure the integrity of a trusted platform beyond the initial boot sequence. For example, user space entities for critical applications (such as an “nit” program) and libraries. For example, additional tables or files, similar to the module configuration file, can be maintained and can be extended to a PCR in the manner described for the configuration file.

In a preferred embodiment, the kernel maintains the integrity of the configuration files. In other embodiments it may be useful to use digital signatures that are checked by an outside authentication source to protect the integrities for user space entities because such entities are more likely to be changed from time-to-time such as when a user upgrades a software package. In cases where user space entities need to be checked network connections are usually more accessible (as opposed to during a boot sequence) and needed network modules would already be loaded.

Another mechanism to extend a trusted platform with additional libraries and software is though using of Extended Executable Linking Format (EELF) discussed in the related patents reference above. In that mechanism, trusted software includes a self-signed attachment, the EELF, which provides signature for verification of the software. This mechanism can be used to establish a trusted platform, or in combination with the invention to provide a flexible trusted platform.

Once the kernel has obtained the KAD it can use it to authorize use of other keys in the hierarchy. Some of these keys can be used as internal keys for internal signature purposes. When an internal signature mode is in operation (e.g., when the device is not connected to a network, when a condition or parameter is set by the manufacturer, etc.) then when an item of data is desired to be encrypted the encryption can proceed identically to the case where an external signature is used. For example, the data item can be encrypted with a symmetrical key, the symmetrical key along with the encrypting platform's identification and a hash value computed over the data item is signed with the internal key. The encrypted and internally signed data item can then be transferred to a receiving device as a data package for storage. Transfers can be over communications systems or smaller networks (e.g., IEEE 1394, Universal Synchronous Bus (USB), home network, etc.)

An internally signed data item is intended to use internally in the same device. If it is an application, it can only be verified and run in the same device. If the application moved to a different device of the same type, it will not run because it cannot be verified. The advantage of internal signing is that the device can verifiy the signature without internet connections, which is very useful for connection limitedt devices.

The internal keys can be updated or expired by an external key authority if the sending and/or receiving devices are connected to a network or other external communications system. For example, keys can be updated when there is a software update of the platform. A revocation list can be generated as a data item and transferred to other devices. Another approach is for the devices to self-expire the internal keys according to a predetermined criterion. For example, a key can expire after a predetermined interval, upon an event, by a message or trigger from an external source, etc. To handle certificate revocation of the original digital signatures of data that has been re-signed, the platform can maintain a list of the original digital signatures. The platform (i.e., the kernel process) can occasionally retrieve CRLs and otherwise re-verify the digital signatures to make sure that they have not been revoked.

Both external and internal keys can be used to sign a particular data item or package. In a preferred embodiment, a kernel process performs both signings but in other embodiments other processes can perform one or more of the signings.

An embodiment of the invention allows a device to perform re-signing of data items. Resigning of data with a standard signature uses a standard signature that is first verified by traversing an authority chain, using a network connection if necessary. Then the data is resigned with a trusted key pair local to the platform. One benefit of the re-signing approach is that it does not require a network connection or traversal of an authority chain when the component is used after the initial verification. In a preferred embodiment, the key used to verify the data is protected so that an unauthorized entity does not replace the key with a key that matches the key used to re-sign data.

Although the invention has been described with respect to specific embodiments thereof, these embodiments are merely illustrative, and not restrictive, of the invention. For example, although a preferred embodiment of the invention discussed above uses a TPM to store, check PCRs and release the KAD, an alternative implementation can “seal” the KAD to the PCR values. For example, a type of sealing operation is defined in the TCG specifications. The sealing operation takes place inside of TPM and can only be unsealed in the same TPM with the same PCR configuration. Thus, this approach can be compatible with current TCG specifications. The authorization data for an unsealing process can be protected, as desired. This approach does not need to restrict the KAD from being read more than once.

Although the invention may be presented with respect to a specific hardware device, such as a DVD player, audio player, computer system, etc., any suitable type of hardware or device can be used with the present invention. Also, although specific processes such as a boot-loader, kernel, operating system, application, service, TCG, etc., may be mentioned, in general any type of process or combination of software and hardware may be used to achieve the desired functionality. In general, other embodiments can use any number of processes, modules, or other program or data structures or organizations. Although the invention may be discussed primarily with respect to specific media types such as optical, magnetic, solid state, etc., any type of storage media type, information source or device can be used.

Any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

Although specific types and numbers of tools, utilities, routines or other programs and functionality has been presented, the functionality provided by embodiments of the invention can be provided by many different design approaches. For example, more or less than six tools can be used. A different ordering of functions (i.e., tool execution) may be desirable in different embodiments. Different designs can include combined functionality of several tools into one, or functions can be allocated to more than six tools. It may be possible and desirable to omit functions described herein in some embodiments. Different embodiments can include more or less automation and more or less manual intervention. Features can be added, deleted, or modified, as, for example, to accommodate future computer operating systems, applications, utilities, drivers or other components.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures,-materials, or operations are not specifically shown or described in detail to avoid obscuring aspects of embodiments of the present invention.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for securing data items transferred from a sending device to a receiving device, the method comprising
storing a plurality of internal keys in a secure data area of the sending device;
storing a plurality of corresponding internal keys in a secure data area of the receiving device;
using a first one of the internal keys in the sending device to sign a first data item at the sending device;
transferring the signed first data item to the receiving device;
using a first internal key at the receiving device to verify the integrity of the first data item, wherein the first internal key at the receiving device corresponds to the first one of the internal keys in the sending device;
selecting a second one of the internal keys in the sending device, wherein the selecting is done without communication external to the sending device;
using the selected internal key to sign a second data item;
transferring the signed second data item to the receiving device; and
using a second internal key at the receiving device to verify the integrity of the second data item, wherein the second internal key at the receiving device corresponds to the second one of the internal keys in the sending device, wherein the second internal key at the receiving device is selected without communication external to the receiving device.

2. The method of claim 1, further comprising
using a criterion stored at a particular device to revoke a key the particular device.

3. The method of claim 1, further comprising
using a kernel process to obtain the first and second ones of the internal keys in the sending device.

4. The method of claim 3, further comprising
using the kernel process to obtain a key after the kernel process is verified and loaded.

5. The method of claim 3, further comprising
obtaining a key from a secure storage location.

6. The method of claim 5, wherein the secure storage location can only be accessed once by the kernel process after a boot procedure.

7. The method of claim 1, further comprising
expiring a key.

8. The method of claim 1, further comprising
generating a revocation list to expire a key.

9. The method of claim 1, further comprising
using an external key to sign a particular data item; and
using an internal key to sign the particular data item.

10. An apparatus method for securing data items transferred from a sending device to a receiving device, the apparatus comprising
a processor;
a machine-readable medium including instructions executable by the processor for performing the following:
storing a plurality of internal keys in a secure data area of the sending device;
storing a plurality of corresponding internal keys in a secure data area of the receiving device;
using a first one of the internal keys in the sending device to sign a first data item at the sending device;
transferring the signed first data item to the receiving device;
using a first internal key at the receiving device to verify the integrity of the first data item, wherein the first internal key at the receiving device corresponds to the first one of the internal keys in the sending device;
selecting a second one of the internal keys in the sending device, wherein the selecting is done without communication external to the sending device;
using the selected internal key to sign a second data item;
transferring the signed second data item to the receiving device; and
using a second internal key at the receiving device to verify the integrity of the second data item, wherein the second internal key at the receiving device corresponds to the second one of the internal keys in the sending device, wherein the second internal key at the receiving device is selected without communication external to the receiving device.

11. A machine-readable medium including instructions for securing data items transferred from a sending device to a receiving device, the machine readable medium including
one or more instructions for'storing a plurality of internal keys in a secure data area of the sending device;
one or more instructions for storing a plurality of corresponding internal keys in a secure data area of the receiving device;
one or more instructions for using a first one of the internal keys in the sending device to sign a first data item at the sending device;
one or more instructions for transferring the signed first data item to the receiving device;
one or more instructions for using a first internal key at the receiving device to verify the integrity of the first data item, wherein the first internal key at the receiving device corresponds to the first one of the internal keys in the sending device;
one or more instructions for selecting a second one of the internal keys in the sending device, wherein the selecting is done without communication external to the sending device;
one or more instructions for using the selected internal key to sign a second data item;
one or more instructions for transferring the signed second data item to the receiving device; and
one or more instructions for using a second internal key at the receiving device to verify the integrity of the second data item, wherein the second internal key at the receiving device corresponds to the second one of the internal keys in the sending device, wherein the second internal key at the receiving device is selected without communication external to the receiving device.
